(19) United States
(12) Patent Application Publication
(10) Pub. No.: US 2026/0139450 A1
(43) Pub. Date: May 21, 2026

(54) ANCHOR CAGE FOR A WIND TURBINE FOUNDATION HAVING A COUPLER FOR CABLES AND METHOD OF MAKING SAME

(71) Applicant: Vestas Wind System A/S, Aarhus N. (DK)

(72) Inventors: Jose Ramon Carril Gonzalez, Burgos (ES); Jorge Canet Yuste, Aarhus N (DK); Alberto Ortiz Guemes, Madrid (ES)

(21) Appl. No.: 19/482,822

(22) PCT Filed: Jul. 3, 2025
(86) PCT No.: PCT/DK2025/050115

§ 371 Date: Nov. 10, 2025

(30) Foreign Application Priority Data
Jul. 11, 2024 (DK) PA202430404

(51) Int. Cl. E02D 27/42; F03D 13/20

(52) U.S. Cl. CPC E02D 27/425; F03D 13/206; E02D 2250/0023; E02D 2300/002; E02D 2600/20; E02D 2600/30

(57) ABSTRACT

An anchor cage (30) for a wind turbine foundation (26 ) includes an upper load distribution flange (32), a lower base flange (34), a plurality of anchor bolts (36) coupling the upper load distribution flange (32) and the lower base flange (34), and a floating coupler (48, 48′, 48″) suspended on one anchor bolt of the plurality of anchor bolts (36). The floating coupler (48, 48′, 48″) includes a first coupler plate (54), a second coupler plate (56), and a plurality of connecting members connecting the first coupler plate (54) and the second coupler plate (56). A first portion of one anchor bolt (36) extends between and is coupled to the upper load distribution flange (32) and a first coupler plate (54) and a second portion of one anchor bolt (36) extends between and is coupled to the second coupler plate (56) and the lower base flange (34). An area bounded by the first coupler plate (54) and the second coupler plate (56) defines a passage (50) through the at least one floating coupler (48, 48′, 48″).

### TECHNICAL FIELD

This application relates generally to wind turbines, and more particularly to an anchor cage of a wind turbine foundation having a floating coupler that allows power cables to pass through the anchor cage. The application also relates to a foundation having and anchor cage with a floating coupler and to a method of forming such a foundation.

### BACKGROUND

Wind turbines are used to produce electrical energy using a renewable resource and without combusting a fossil fuel. Generally, a wind turbine converts kinetic energy from the wind into electrical power. A horizontal-axis wind turbine generally includes a tower, a nacelle located at the apex of the tower, and a rotor having a plurality of blades and supported in the nacelle by a shaft. The shaft couples the rotor either directly or indirectly with a generator, which is housed inside the nacelle. Consequently, as wind forces the blades to rotate, electrical energy is produced by the generator.

Wind turbines may be anchored on land by securing a lower portion, such as a lower tower flange, of the wind turbine tower to a foundation that extends into the ground. Conventional foundations include steel-reinforced concrete structures arranged within an excavation pit. The structure includes a centrally positioned anchor cage that is generally cylindrical in shape and includes upper and lower annular flanges arranged horizontally, and a plurality of high-strength anchor bolts extending vertically between the flanges.

To transport generated electrical energy away from the wind turbine, e.g., to the power grid, a wind turbine generally includes at least one power cable. The power cable typically extends through the wind turbine tower and a height of the foundation. A trench is dug so that the power cable exits the wind turbine through a bottom of the foundation. Such an approach can present problems depending on the particular geological makeup of the ground where the wind turbine is to be located. For example, if the site where the wind turbine is to be erected is made of up of tough rock or hard soil, it can be expensive, time consuming, and labor intensive to dig a trench for the power cable-particularly, at a depth below the foundation. Further, routing the power cable through the wind turbine tower and under the foundation requires a substantial length of costly power cable.

Accordingly, there is a need for an improved wind turbine foundation. More particularly, there is a need for a wind turbine foundation that reduces the amount of trenching necessary for routing the power cable from the wind turbine. Additionally, there is a need for a wind turbine foundation that minimizes the length of power cable necessary to transport electrical energy from the wind turbine.

### SUMMARY

Certain exemplary aspects of the invention are set forth below. It should be understood that these aspects are presented merely to provide the reader with a brief summary of certain forms the invention might take and that these aspects are not intended to limit the scope of the invention.

In one aspect of the invention, an anchor cage for a wind turbine foundation is provided. The anchor cage includes an upper load distribution flange configured to engage a lower tower flange of a wind turbine and a lower base flange located a distance from the upper load distribution flange. The anchor cage also includes a plurality of anchor bolts extending between and coupled to the upper load distribution flange and the lower base flange. The anchor cage also includes at least one floating coupler suspended on at least one anchor bolt of the plurality of anchor bolts. The at least one floating coupler includes a first coupler plate, a second coupler plate arranged a distance from the first coupler plate, and a plurality of connecting members connecting the first coupler plate and the second coupler plate. A first portion of the at least one anchor bolt extends between and is coupled to the upper load distribution flange and a first coupler plate and a second portion of the at least one anchor bolt extends between and is coupled to the second coupler plate and the lower base flange. An area bounded at least partially by the first coupler plate and the second coupler plate defines a passage through the at least one floating coupler.

In one embodiment, each of the plurality of connecting members may be a connecting rod. Each connecting rod may extend between and be coupled to the first coupler plate and the second coupler plate. Further, a combined tensile strength of the plurality of connecting rods is approximately equal to or greater than the tensile strength of the at least one anchor bolt.

In another embodiment, the first coupler plate and the second coupler plate include a foam layer on a top surface thereof. The foam layer may be configured to at least partially facilitate a transfer of tension between the plurality of connecting members and the at least one anchor bolt.

In another embodiment, at least one of the first coupler plate or the second coupler plate may include a coating on a surface thereof. The coating may be configured to at least partially facilitate a transfer of tension between the plurality of connecting members and the at least one anchor bolt.

In one embodiment, the plurality of anchor bolts may include a plurality of radially inner anchor bolts and a plurality of radially outer anchor bolts separated by a radial distance. And the at least one floating coupler may include a first floating coupler suspended on a radially inner anchor bolt of the plurality of radially inner anchor bolts at a first axial height and a second floating coupler suspended on a radially outer anchor bolt of the plurality of radially outer anchor bolts at a second axial height The first axial height and the second axial height may be substantially the same.

In another embodiment, the at least one floating coupler may be suspended on the at least one anchor bolt such that a first distance from the upper distribution flange to the first coupler plate is less than a second distance from the lower base flange to the second coupler plate. In another embodiment, the at least one floating coupler may be suspended on the at least one anchor bolt such that a first distance from the upper distribution flange to the first coupler plate is substantially equal to a second distance from the lower base flange to the second coupler plate.

In another embodiment, a width of the passage of the at least one floating coupler may be greater than a distance between a first anchor bolt and an adjacent second anchor bolt of the plurality of anchor bolts. Further, the at least one anchor bolt may include a first anchor bolt and a second anchor bolt and the at least one floating coupler may be suspended on at least the first anchor bolt and the second anchor bolt. Further, the at least one floating coupler may include a plurality of floating couplers and the plurality of floating couplers may be arranged circumferentially spaced about the anchor cage.

In another aspect of the invention, a foundation for a wind turbine is provided. The foundation includes an anchor cage. The anchor cage includes an upper load distribution flange configured to engage a lower tower flange of the wind turbine and a lower base flange located a distance from the upper load distribution flange. The anchor cage also includes a plurality of anchor bolts extending between and coupled to the upper load distribution flange and the lower base flange. The anchor cage also includes at least one floating coupler suspended on at least one anchor bolt of the plurality of anchor bolts. The at least one floating coupler includes a first coupler plate, a second coupler plate arranged a distance from the first coupler plate, and a plurality of connecting members connecting the first coupler plate and the second coupler plate. The floating coupler is configured to be suspended on at least one anchor bolt such that a first portion of the at least one anchor bolt is coupled to the first coupler plate and a second portion of the at least one anchor bolt is coupled to the second coupler plate. An area bounded at least partially by the first coupler plate and the second coupler plate defines a passage through the at least one floating coupler. The foundation further includes a rigid body at least partially formed around the anchor cage. A conduit for a power cable passes through the passage in the foundation provided by the at least one floating coupler between an interior of the foundation and an exterior of the foundation.

In one embodiment, the first coupler plate and the second coupler plate include a foam layer on a top surface thereof. The foam layer may be configured to at least partially facilitate a transfer of tension between the plurality of connecting members and the at least one anchor bolt.

In another aspect of the invention, a floating coupler for a wind turbine foundation anchor cage is provided. The floating coupler includes a first coupler plate and a second coupler plate arranged a distance from the first coupler plate. The floating coupler also includes a plurality of connecting members connecting the first coupler plate and the second coupler plate. The floating coupler is configured to be suspended on at least one anchor bolt. A first portion of the at least one anchor bolt is coupled to the first coupler plate and a second portion of the at least one anchor bolt is coupled to the second coupler plate. An area bounded at least partially by the first coupler plate and the second coupler plate defines a passage through the at least one floating coupler.

In another aspect of the invention, a method of forming a wind turbine foundation is provided. The method includes providing an anchor cage in an excavation pit formed in a ground surface. The anchor cage includes an upper load distribution flange configured to engage a lower tower flange of a wind turbine, a lower base flange located a distance from the upper load distribution flange, a plurality of anchor bolts extending between and coupled to the upper load distribution flange and the lower base flange, and at least one floating coupler suspended on at least one anchor bolt of the plurality of anchor bolts. The at least one floating coupler includes a first coupler plate, a second coupler plate arranged a distance from the first coupler plate, and a plurality of connecting members connecting the first coupler plate and the second coupler plate. An area bounded at least partially by the first coupler plate and the second coupler plate defines a passage through the at least one floating coupler. The method further includes directing a cementitious material into the excavation pit so that the anchor cage becomes at least partially embedded within the cementitious material. The method further includes allowing the cementitious material to cure to form a rigid body.

It will be understood that the various embodiments and aspects described above can be combined in any combination or sub-combination without departing from the scope of this disclosure.

### BRIEF DESCRIPTION OF THE DRAWINGS

The accompanying drawings are included to provide a further understanding and are incorporated in and constitute a part of this specification. The drawings illustrate one or more embodiments, and together with the description serve to explain principles and operation of the various embodiments. Features and attributes associated with any of the embodiments shown or described may be applied to other embodiments shown, described, or appreciated based on this disclosure.

FIG. 1 is a perspective view of wind turbine coupled to a foundation, shown schematically.

FIG. 2 is a perspective view of an anchor cage for use with a wind turbine foundation according to an embodiment of the invention, the anchor cage including several floating couplers.

FIG. 3 is an upper radial cross-sectional view of a wind turbine foundation according to an embodiment of the invention, the foundation including a rigid body reinforced by the anchor cage of FIG. 2.

FIG. 4 is an upper radial cross-sectional view similar to FIG. 3, showing a cross-section of the anchor cage including two floating couplers.

FIG. 5 is a perspective view of a floating coupler according to an embodiment of the invention.

FIG. 6 is a front, detail view of a coupler plate of a floating coupler, according to an embodiment of the invention.

FIG. 7 is a front, detail view of another coupler plate of a floating coupler, according to an embodiment of the invention.

FIG. 8 is a front, detail view of another coupler plate of a floating coupler, according to an embodiment of the invention.

FIG. 9 is a perspective view of another floating coupler, according to an embodiment of the invention.

FIG. 10 is a perspective view of another floating coupler, according to an embodiment of the invention.

FIG. 11 is a perspective view of another floating coupler, according to an embodiment of the invention.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure.

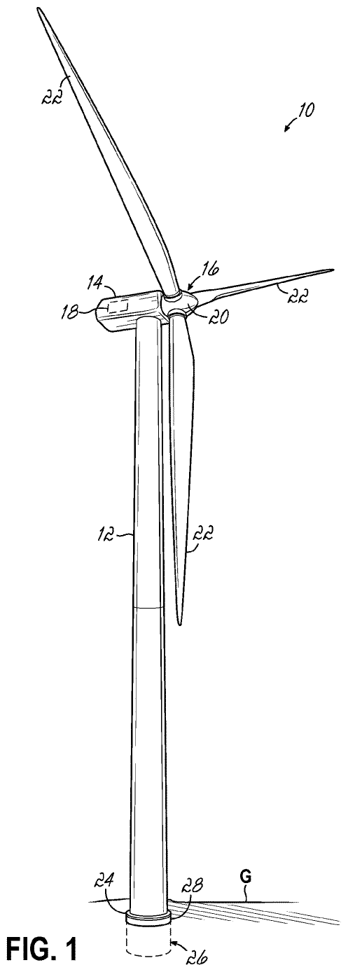

Referring now to FIG. 1, the Figure shows an exemplary horizontal-axis wind turbine 10. The horizontal-axis wind turbine 10 generally includes a tower 12, a nacelle 14 disposed at the apex of the tower 12, and a rotor 16 operatively coupled to a generator 18 housed inside the nacelle 14. In addition to the generator 18, the nacelle 14 houses miscellaneous components required for converting wind energy into electrical energy and various components needed to operate, control, and optimize the performance of the wind turbine 10. The tower 12 supports the load of the nacelle 14, the rotor 16, and other components of the wind turbine 10 that are housed inside the nacelle 14. The tower 12 further operates to elevate the nacelle 14 and the rotor 16 to a height above ground level, at which faster moving air currents of lower turbulence are typically found.

The rotor 16 of the wind turbine 10 serves as the prime mover for the electromechanical system. Wind exceeding a minimum level will activate the rotor 16 and cause rotation in a substantially perpendicular direction to the wind direction. The rotor 16 of wind turbine 10 includes a central hub 20 and a plurality of blades 22 that project outwardly from the central hub 20 at locations circumferentially distributed thereabout. While the exemplary rotor 16 shown herein includes three blades 22, various other quantities of blades 22 may be provided. The blades 22 are configured to interact with the passing air flow to produce lift that causes the rotor 16 to spin generally within a plane defined by the blades 22.

The wind turbine 10 may be included among a collection of similar wind turbines belonging to a wind farm or wind park that serves as a power generating plant connected by transmission lines with a power grid, such as a three-phase alternating current (AC) power grid. The power grid generally consists of a network of power stations, transmission circuits, and substations coupled by a network of transmission lines that transmit the power to loads in the form of end users and other customers of electrical utilities. Under normal circumstances, the electrical power is supplied from the generator 18 to the power grid as known to a person having ordinary skill in the art.

The wind turbine 10 is anchored to a ground surface G by securing a lower tower flange 24 of the tower 12 to a foundation 26, shown schematically. The foundation 26 is recessed in an excavation pit, or void, formed in the ground G. The completed foundation 26 generally includes a rigid body 28 (e.g., formed of concrete), an anchor cage 30 at least partially embedded within and reinforcing the rigid body 28, and may further include a grout support layer (not shown) positioned between the upper load distribution flange 32 of the anchor cage 30 and an upper surface of the rigid body 28.

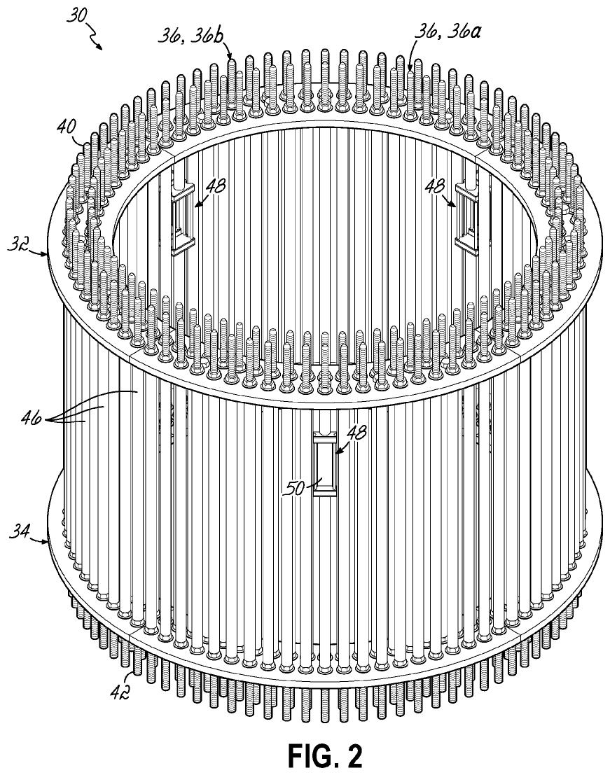

Referring now to FIG. 2, formation of the foundation 26 begins with the assembly of the anchor cage 30, which may be performed at the wind turbine installation site. The assembled anchor cage 30 is generally cylindrical and includes the upper load distribution flange 32, a lower base flange 34, and a plurality of circumferentially spaced anchor bolts 36 extending between the upper load distribution flange 32 and the lower base flange 34. The upper load distribution flange 32 and lower base flange 34 may be arranged generally horizontally, while the anchor bolts 36 may extend generally vertically (e.g., substantially perpendicular to the upper load distribution flange 32 and lower base flange 34) and couple the upper load distribution flange 32 to the lower base flange 34. The upper load distribution flange 32 and the lower base flange 34 may be generally circular, and in particular, annular, for example. According to one embodiment, the components of the anchor cage 30 may be formed of high strength steel, for example. According to one aspect of the invention, the anchor cage 30 of FIG. 2 includes a number of floating couplers 48, described in greater detail below.

In one embodiment, the anchor cage 30 may include approximately 64 to 200 radial pairs of anchor bolts 36 and corresponding bolt bores 38 formed on each of the upper load distribution flange 32 and the lower base flange 34. In the illustrated embodiment shown in FIG. 2, the anchor cage 30 includes 84 radial pairs of anchor bolts 36. It will be appreciated that other quantities of anchor bolts 36 and bolt bores 38 are possible. Additionally, according to one embodiment, the anchor bolts 36 are up to 4.5 meters long and 42 millimeters in diameter. However, other dimensions are also possible.

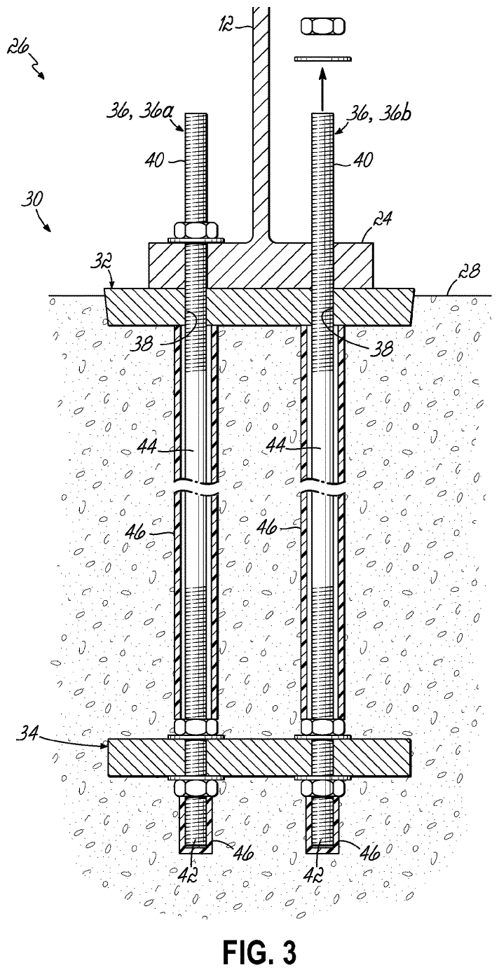

Referring now to FIG. 3, the Figure shows a radial pair of anchor bolts 36 of a representative circumferential portion of the anchor cage 30. Each anchor bolt 36 extends longitudinally and includes a threaded upper end 40, a threaded lower end 42, and a central shank 44. Prior to assembling the anchor bolts 36 with the upper load distribution flange 32 and the lower base flange 34, the threaded upper end 40 of each anchor bolt 36 may be sealed with a protective covering, as will be described in greater detail below.

The upper load distribution flange 32 includes a plurality of circumferentially spaced bolt bores 38 through which threaded upper ends 40 of the anchor bolts 36 are received. It will be appreciated that the lower base flange 34 likewise includes a corresponding plurality of bolt bores 38 through which threaded lower ends 42 of the anchor bolts 36 are received. The bolt bores 38 are arranged into a radially inner ring 38a for receiving a radially inner anchor bolt 36a of the anchor bolts 36, and a radially outer ring 38b for receiving a radially outer anchor bolt 36b of the anchor bolts 36. The radially inner and the radially outer rings 38a, 38b may be radially aligned with one another such that the bolt bores 38 and respective anchor bolts 36 are arranged into circumferential spaced radial pairs, as shown in FIG. 2. The bolt bores 38 may be uniformly spaced circumferentially around the upper load distribution flange 32 and the lower base flange 34.

With continued reference to FIG. 3, the portion of the anchor bolt 36 extending between the upper load distribution flange 32 and the lower base flange 34 may be encased within a protective sleeve 46, such as PVC pipe, heat shrink hose, or tape, for example. An additional protective sleeve 46 may be placed on the portion of the anchor bolt 36 extending below the lower base flange 34. Advantageously, the protective sleeves 46 may substantially shield the anchor bolts 36 from undesired contact and bonding with the rigid body 28 (e.g., concrete) during pouring and curing of the rigid body 28.

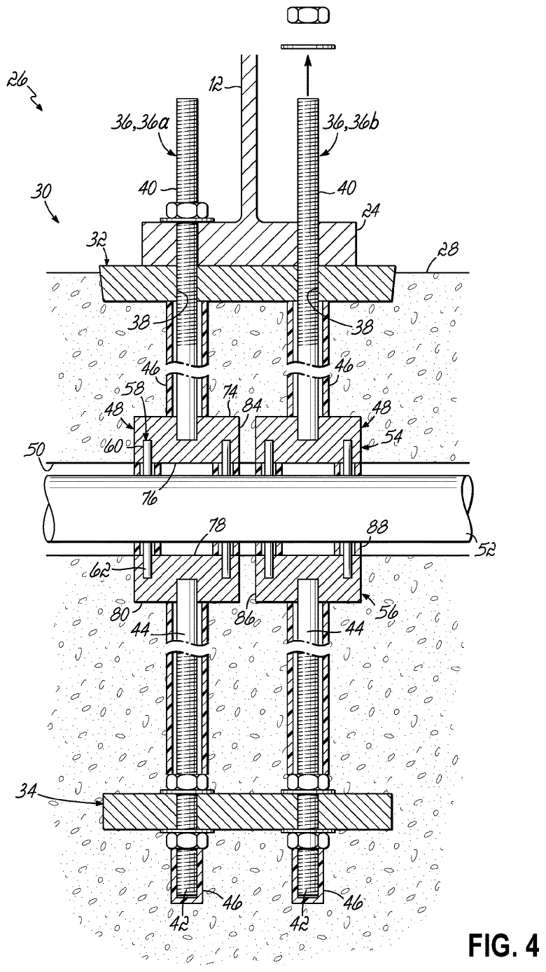

Referring now to FIG. 4, the Figure shows a radial pair of anchor bolts 36 of a further representative circumferential portion of the anchor cage 30. In this representative circumferential portion of the anchor cage 30, each of the anchor bolts 36 includes a floating coupler 48. To create a passage 50 through the anchor cage 30, the floating coupler 48 arranged on the radial inner anchor bolt 36a and the floating coupler 48 arranged on the radial outer anchor bolt 36b are located at approximately the same axial height of the respective anchor bolts 36a, 36b. Each of the floating couplers 48 are configured to create a passage 50 (or window) or at least a portion of a passage 50 (or window) in the anchor cage 30 (and thus in the foundation 26) such that one or more cables, such as a power cable 52, can pass through the foundation 26 in a direction transverse to the long axis (e.g., height) of the anchor cage 30. As best shown in FIG. 2, the anchor cage 30 may include a number of floating couplers 48 that provide one or more passages 50 (or windows) between an interior and an exterior of the anchor cage 30. For example, the anchor cage 30 may include three passages 50 (each passage created by two floating couplers 48, for a total of six floating couplers 48). It should be understood that the anchor cage 30 may include more or fewer than three passages 50. One or more tubes or other covers may be used to prevent the passage(s) 50 (or window(s)) through the anchor cage 30, created by the floating couplers 48, from becoming filed with the material of rigid body 28 (e.g., concrete) when the rigid body 28 is formed (e.g., poured and cured).

Advantageously, this passage 50 (or window) formed in the anchor cage 30 eliminates the need for a cable, such as a power cable 52, to exit through a bottom of the foundation 26 as is traditionally done. In other words, instead of routing the power cable 52 around the bottom of the foundation 26, the power cable 52 can simply pass through the anchor cage 30 via the passage 50. This routing of the power cable 52 through the passage 50 in the anchor cage 30 reduces the amount of trenching necessary for routing the power cable 52. This results in significant time, labor, and cost savings. Additionally, the routing of the power cable 52 through the passage 50 in the anchor cage 30 reduces the length of power cable 52 needed to transport electrical energy away from the wind turbine 10. This results in significant cost savings. As best shown in FIG. 2, the floating coupler 48 may be located near to the upper load distribution flange 32 (e.g., closer to the upper load distribution flange 32 than to the lower base flange 34). Such an arrangement serves to maximize the benefits of the floating coupler 48 by minimizing the length of power cable 52 required as well as minimizing the amount of trenching necessary for routing the power cable 52 away from the wind turbine 10. However, it should be understood that the floating coupler 48 could be differently located (e.g., approximately equidistant between the upper load distribution flange 32 and the lower base flange 34) while still providing at least a substantial portion of the above-described benefits.

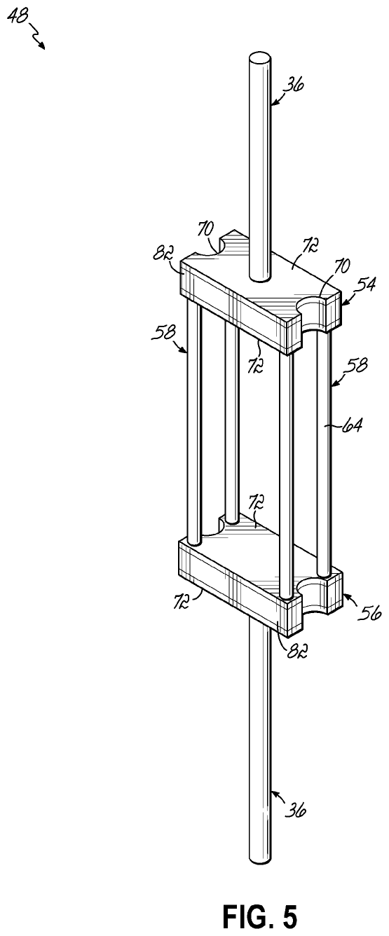

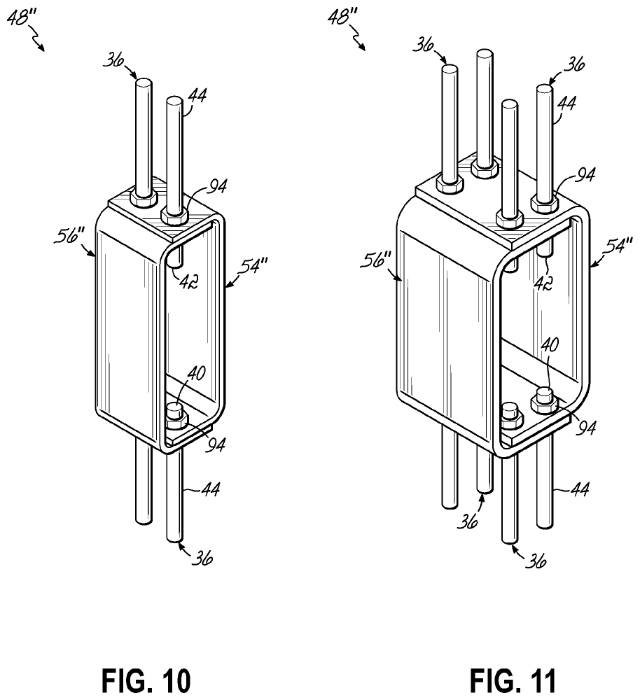

Referring now to FIG. 5, the Figure shows an embodiment of a floating coupler 48. In the depicted embodiment, the floating coupler 48 includes a first coupler plate 54 and a second coupler plate 56 connected by a plurality of connecting members. In the depicted embodiment, the connecting members are connecting rods 58. However, as will be discussed in greater detail below with respect to FIGS. 10 and 11, the connecting members may take on other forms. The coupler plates 54, 56 and the connecting rods 58 may be made of high-strength steel, for example. Moreover, the connecting rods 58 may be protected by a casing/covering, e.g., PE tube, heat shrink, grease, silicone, or the like, to avoid adherence with the concrete. A distance between the first coupler plate 54 and the second coupler plate 56 (i.e., a height of the floating coupler 48) is sufficient to allow at least one cable, e.g., a power cable 52, to pass through the floating coupler 48. However, it should be understood that the distance between the first coupler plate 54 and the second coupler plate 56 (i.e., a height of the floating coupler 48) may be sufficient to allow multiple cables, e.g., power cables 52, to pass through the floating coupler 48. In one embodiment (e.g., for longer anchor cages 30), a distance between the first coupler plate 54 and the second coupler plate 56 may be at least 5% of the distance between the upper load distribution flange 32 and the lower base flange 34 of the anchor cage 30. In another embodiment (e.g., for shorter anchor cages 30), a distance between the first coupler plate 54 and the second coupler plate 56 may be at least 50% of the distance between the upper load distribution flange 32 and the lower base flange 34 of the anchor cage 30. In a further embodiment, a distance between the first coupler plate 54 and the second coupler plate 56 may be substantially the entire distance between the upper load distribution flange 32 and the lower base flange 34 of the anchor cage 30. In the depicted embodiment, the floating coupler 48 includes four connecting rods 58. It should be understood that more or fewer connecting rods 58 could be used. A distance between neighboring connecting rods 58 in a tangential direction of the anchor cage 30 (e.g., a width of the floating coupler 48) may be approximately twice the distance between anchor bolts 36 of the anchor cage 30 in the same direction. In other words, the passage 50 (or window) created by the floating coupler 48 may be about twice as wide as the (tangential) spacing between anchor bolts 36.

Further, a cross-sectional area of each connecting rod 58 may be approximately 1/n of the cross-sectional area of an anchor bolt 36, where n is the number of connecting rods 58 used in the floating coupler 48. In other words, the sum of the cross-sectional areas of the connecting rods 58 may be substantially equivalent to the cross-sectional area of the anchor bolt 36. For example, in the depicted embodiment, the cross-sectional area of each connecting rod 58 is approximately one fourth the cross-sectional area of the anchor bolt 36. In another embodiment, however, a combined tensile strength of the plurality of connecting rods 58 may be approximately equal to or greater than the tensile strength of at least one anchor bolt 36.

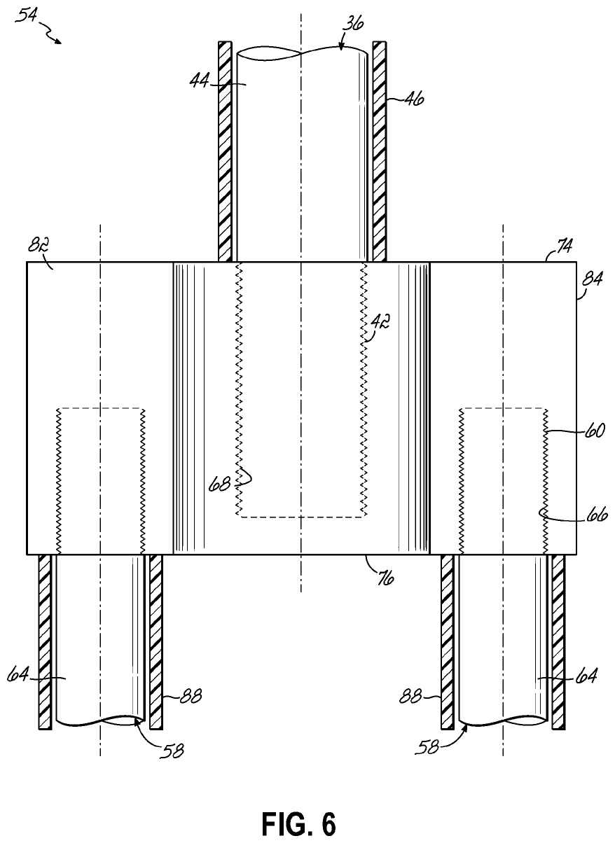

With continued reference to FIG. 5, each connecting rod 58 extends longitudinally between the first coupler plate 54 and the second coupler plate 56 and includes a threaded upper end 60, a threaded lower end 62, and a central shank 64. The first coupler plate 54 includes a plurality of rod bores 66 through which (or in which) the threaded upper ends 60 of the connecting rods 58 are received. It will be appreciated that the second coupler plate 56 likewise includes a corresponding plurality of rod bores 66 through which (or in which) threaded lower ends 42 of the connecting rods 58 are received. In the depicted embodiment, the rod bores 66 are located at or near the corners of the first and second coupler plates 54, 56. It will be understood that the rod bores 66 could be at other locations. As will be explained in greater detail below (with respect to FIGS. 6-8), the rod bores 66 may extend partially or fully through the first and second coupler plates 54, 56.

The first coupler plate 54 and the second coupler plate 56 are substantially planar, but it should be understood that the first and second coupler plates 54, 56 could take on other forms. In the depicted embodiment, the first coupler plate 54 includes a bolt bore 68 through which (or in which) the threaded lower end 42 of an anchor bolt 36 is received. It will be appreciated that the second coupler plate 56 likewise includes a corresponding bolt bore 68 through which (or in which) threaded upper end 40 of an anchor bolt 36 is received. In the depicted embodiment, the bolt bore 68 is located at or near a center of each of the first and second coupler plates 54, 56. It will be understood that the bolt bore 68 could be at other locations. As will be explained in greater detail below (with respect to FIGS. 6-8), the bolt bore 68 may extend partially or fully through each of the first and second coupler plates 54, 56.

With continued reference to FIG. 5, both of the first and second coupler plates 54, 56 include notches 70 on opposing lateral ends thereof. The notches 70 are shaped and located so as receive the central shank 44 of a neighboring anchor bolt 36 when a floating coupler 48 is arranged in an anchor cage 30. Specifically, in the depicted embodiment, the notches 70 are semicircular and are complementary in shape to the central shank 44 of the anchor bolts 36. Such is best shown in FIG. 2. However, it should be understood that the shape and location of the notches 70 could vary. The inclusion of the notches 70 serves to maximize the width of the coupler plates 54, 56 (and thus the passage 50). Without the notches 70, the width of the coupler plates 54, 56 would be reduced. Further, in the depicted embodiment, the first coupler plate 54 and the second coupler plate 56 are identical (but arranged in different orientations). However, it should be understood that the first coupler plate 54 and the second coupler plate 56 may not necessarily be identical.

The floating coupler 48 includes a number of features to prevent (or at least minimize) the floating coupler 48 and/or portions thereof from adhering to the rigid body 28 (e.g., concrete). Particularly, the first coupler plate 54 includes a foam layer 72 deposited on and/or adhered to a top surface 74 and a bottom surface 76 of the first coupler plate 54. The foam layer 72 may be EVA foam, expanded polystyrene, and rubber, for example. It should be understood that a different material could be used. It will be appreciated that the second coupler plate 56 likewise includes a foam layer 72 deposited on and/or adhered to a top surface 78 and a bottom surface 80 of the second coupler plate 56. Advantageously, the foam layer 72 functions to prevent the rigid body 28 (e.g., concrete) from adhering (or bonding) directly to top surfaces 74, 78 and bottom surfaces 76, 80 of the first and second coupler plates 54, 56. More particularly, the foam layer 72 allows for tension in the connecting rods 58 to be passed to the anchor bolts 36 (or vice versa) instead of to the surrounding rigid body 28.

With continued reference to FIG. 5, the first coupler plate 54 includes a coating 82 on and/or adhered to the lateral faces 84 of the first coupler plate 54. The coating 82 may be a plastic coating such as rubber, polyethylene, and plastic, for example, or grease, silicone, or the like. It should be understood that a different material could be used. It will be appreciated that the second coupler plate 56 likewise includes a coating 82 on and/or adhered to the lateral faces 86 of the second coupler plate 56. Advantageously, and similar to the foam layer(s) 72, the coating 82 functions to prevent the rigid body 28 (e.g., concrete) from adhering (or bonding) directly to lateral faces 84, 86 of the first and second coupler plates 54, 56. While the floating coupler 48 in the depicted embodiment makes use of a combination of foam layers 72 and coatings 82 on the coupler plates 54, 56, an another embodiment may instead use one or the other or may use the foam layers 72 and coatings 82 in a different arrangement. For example, in another embodiment of the floating coupler 48 may include a foam layer 72 on the top surface 74, bottom surface 76, and lateral faces 84 of the first coupler plate 54, for example. A further embodiment may include a coating 82 on the top surface 74, bottom surface 76, and lateral faces 84 of the first coupler plate 54, for example. It should be understood that the same is applicable to the second coupler plate 56 as well.

Further, the portion of the anchor bolt 36 extending between the upper load distribution flange 32 and the first coupler plate 54 may be encased within a protective sleeve 46. Likewise, the portion of the anchor bolt 36 extending between the lower base flange 34 and the second coupler plate 56 may be encased within a protective sleeve 46. Similarly, the portion of the connecting rods 58 extending between the first coupler plate 54 and the second coupler plate 56 may be encased within a protective sleeve 88. The protective sleeves 46, 88 are not shown in FIG. 5 for illustrative purposes. The protective sleeves 46, 88 are shown in FIGS. 6-8, for example. The protective sleeve 46 or protective sleeve 88 may be PVC pipe, heat shrink hose, or tape, for example. It should be understood that the protective sleeves 46 and protective sleeves 88 may be made of the same or different material. For example, the protective sleeves 46 encasing the anchor bolts 36 may be PVC pipe, for example, while the protective sleeves 88 encasing the connecting rods 58 may be heat shrink hose, for example. Advantageously, the protective sleeves 46 and the protective sleeves 88 may substantially shield the anchor bolts 36 and connecting rods 58, respectively, from undesired contact and bonding with the rigid body 28 (e.g., concrete) during pouring and curing of the rigid body 28.

With continued reference to FIG. 5, the portion of the anchor bolt 36 arranged between the upper load distribution flange 32 of the anchor cage 30 and the first coupler plate 54 of the floating coupler 48 may include a fuse or otherwise may be purposefully weakened so that the portion of the anchor bolt 36 identified above fails before the connecting rods 58, coupler plates 54, 56, or the portions of the anchor bolt 36 arranged between the second coupler plate 56 and the lower base flange 34 of the anchor cage 30. Such may facilitate easier replacement of the anchor bolt 36.

Referring to FIGS. 6-8, the Figures show various configurations of the first coupler plate 54. It will be appreciated that the same configurations could be applied to the second coupler plate 56. Referring now to FIG. 6, the Figure shows an embodiment of a first coupler plate 54. In this embodiment, the bolt bore 68 and the rod bores 66 are threaded (to receive the threaded lower end 42 of the anchor bolt 36 and threaded lower ends 62 of the connecting rods 58, respectively) and extend only part way through the first coupler plate 54. This configuration eliminates the need to use additional hardware (e.g., washers and nuts) to secure the connecting rods 58 and the anchor bolt 36 to the first coupler plate 54. It should be understood that the anchor bolt 36 and the connecting rods 58 could be connected to the first coupler plate 54 in a different manner. Such a configuration may be desirable to simplify the application of the foam layers 72 and/or coating 82 to the first coupler plate 54.

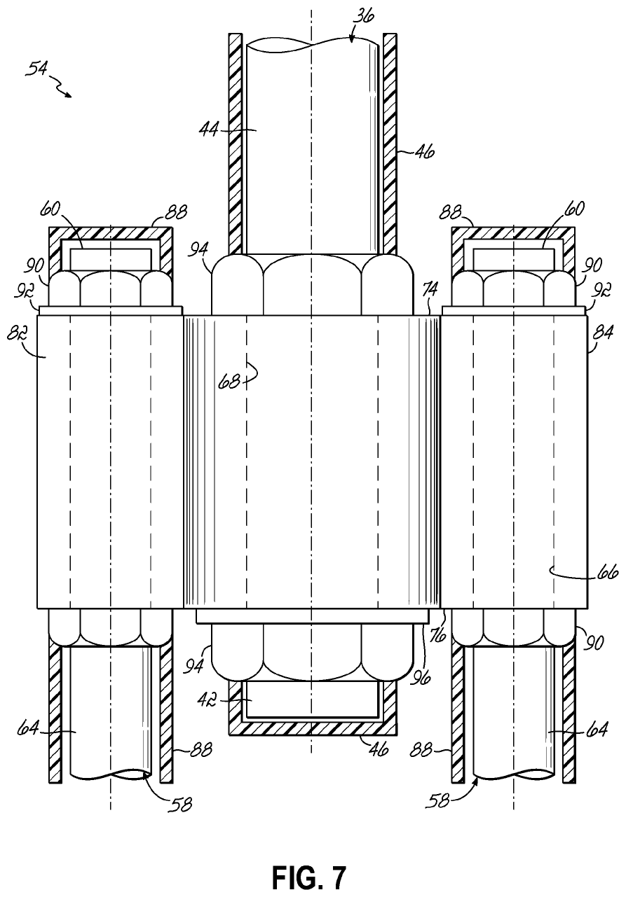

Referring now to FIG. 7, the Figure shows another embodiment of a first coupler plate 54. In this embodiment, the bolt bore 68 and the rod bores 66 extend fully through the first coupler plate 54 and are not threaded. This configuration includes additional hardware (e.g., washers and nuts) to secure the connecting rods 58 and the anchor bolt 36 to the first coupler plate 54. Specifically, each of the connecting rods 58 are secured to the first coupler plate 54 using two nuts 90 (e.g., heavy hex nuts) and a washer 92 (e.g., a flat washer). One nut 90 (e.g., a heavy hex nut) abuts a bottom surface 76 of the first coupler plate 54. The other nut 90 (e.g., a heavy hex nut) abuts a washer 92 (e.g., a flat washer) which abuts a top surface 74 of the first coupler plate 54. Like the connecting rods 58, the anchor bolt 36 is secured to the first coupler plate 54 using two nuts 94 (e.g., a jam nut and a coil nut) and a washer 96. One nut 94 (e.g., a jam nut) abuts a top surface 74 of the first coupler plate 54. The other nut 94 (e.g., a coil nut) abuts a washer 96 which abuts a bottom surface 76 of the first coupler plate 54. It should be understood that the anchor bolt 36 and the connecting rods 58 could be connected to the first coupler plate 54 in a different manner. Further, the portions of the connecting rods 58 that extend beyond a top surface 74 of the first coupler plate 54 may be encased within a protective sleeve 88. The portion of the anchor bolt 36 that extends below a bottom surface 76 of the first coupler plate 54 may also be encased within a protective sleeve 46. The protective sleeve 46 or protective sleeve 88 may be PVC pipe, heat shrink hose, or tape, for example. Such a configuration of the first coupler plate 54 may be desirable to simplify the machining of first coupler plate 54 as well as to simplify the installation of the anchor bolt 36 and the connecting rod 58 to the first coupler plate 54.

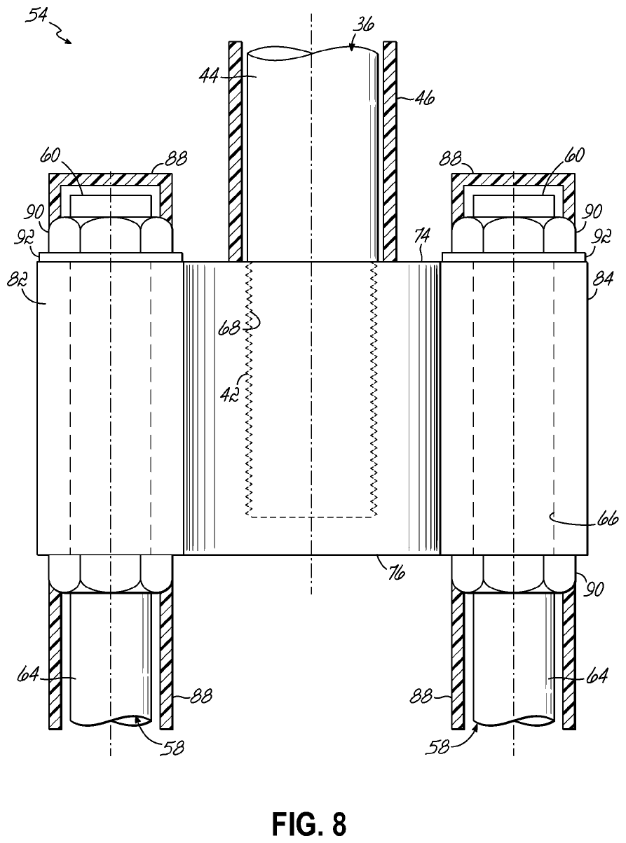

Referring now to FIG. 8, the Figure shows yet another embodiment of a first coupler plate 54. In this embodiment, the bolt bore 68 is threaded (to receive the threaded lower end 42 of the anchor bolt 36) and extends only part way through the first coupler plate 54. In contrast, the rod bores 66 extend fully through the first coupler plate 54 and are not threaded. This configuration includes additional hardware (e.g., washers and nuts) to secure the connecting rods 58 to the first coupler plate 54. Specifically, each of the connecting rods 58 are secured to the first coupler plate 54 using two nuts 90 (e.g., heavy hex nuts) and a washer 92 (e.g., a flat washer). One nut 90 (e.g., a heavy hex nut) abuts a bottom surface 76 of the first coupler plate 54. The other nut 90 (e.g., a heavy hex nut) abuts a washer 92 (e.g., a flat washer) which abuts a top surface 74 of the first coupler plate 54. It should be understood that the anchor bolt 36 and the connecting rods 58 could be connected to the first coupler plate 54 in a different manner. Further, the portions of the connecting rods 58 that extend beyond a top surface 74 of the first coupler plate 54 may be encased within a protective sleeve 88. The protective sleeve 88 may be PVC pipe, heat shrink hose, or tape, for example.

Such a configuration of the first coupler plate 54 may be desirable to strike a balance between the complexity of machining the first coupler plate 54 and the relative difficulty or ease of securing the anchor bolt 36 and the connecting rod 58 to the first coupler plate 54.

Referring generally to FIGS. 6-8, it may be advantageous for the first coupler plate 54 and the second coupler plate 56 to have the same configuration. Such may facilitate easier installation of the floating coupler 48 in the field. However, it will be understood that the first coupler plate 54 and the second coupler plate 56 do not necessarily have to share the same configuration. For example, the first coupler plate 54 could have a configuration as shown in FIG. 6 and the second coupler plate 56 could have a configuration as shown in FIG. 8.

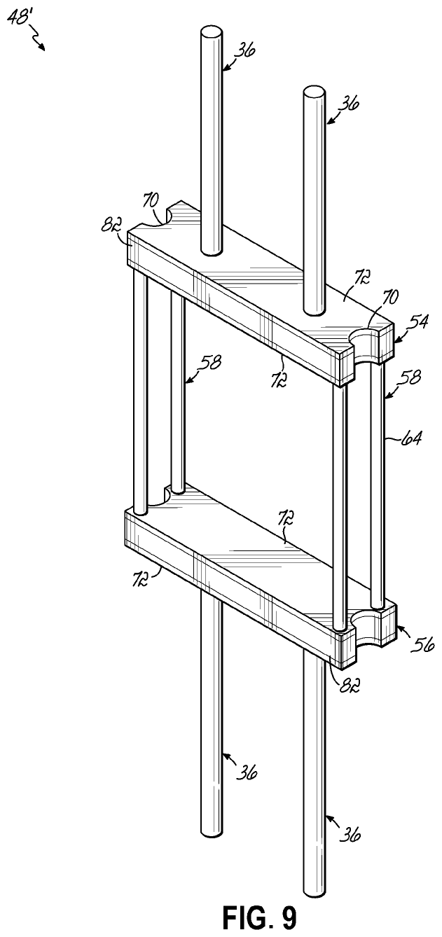

Referring now to FIG. 9, the Figure shows another embodiment of the floating coupler 48′. The floating coupler 48′ of FIG. 9 is similar to the floating coupler 48 of FIG. 5; however, the floating coupler 48′ of FIG. 9 is dimensioned so as to span more than one anchor bolt 36 in the anchor cage 30 in a tangential direction relative to the anchor cage 30. In the depicted embodiment, the floating coupler 48′ spans two anchor bolts 36 in the tangential direction. It should be understood that, in another embodiment, the floating coupler 48′ could be dimensioned so as to span three or more anchor bolts 36 in the tangential direction. Advantageously, dimensioning the floating coupler 48′ so that the floating coupler 48′ spans more than one anchor bolt 36 in the anchor cage 30 in the tangential direction creates a larger passage 50 (or window) through the anchor cage 30 to allow larger diameter cables (e.g., power cable(s) 52) or more cables to pass through the anchor cage 30.

Referring now to FIGS. 10 and 11, the Figures show further embodiments of floating couplers 48″. The floating couplers 48″ of FIGS. 10 and 11 feature first and second coupler plates 54″, 56″ that are substantially C-shaped. The first and second coupler plates 54″, 56″ are dimensioned to nest together to form a passage 50 through which a power cable 52, for example, may pass through. Because of the C-shape of the first and second coupler plates 54″, 56″, these embodiments of the floating coupler 48″ do not include connecting rods 58. Instead, the connecting members in these embodiments are the anchor bolts 36 themselves. Additionally, the floating couplers 48″ of FIGS. 10 and 11 are dimensioned to span more than one anchor bolt 36 in the anchor cage 30 in the radial direction (e.g., between a radially inner anchor bolt 36a and a radially outer anchor bolt 36b). In the depicted embodiment, the floating couplers 48″ span two anchor bolts 36 in the radial direction. It should be understood that, in another embodiment, the floating coupler 48″ could be dimensioned so as to span three or more anchor bolts 36 in the radial direction (if the anchor cage 30 included more than an a radially inner ring of anchor bolts 36a and a radially outer ring of anchor bolts 36b). Advantageously, dimensioning the floating couplers 48″ so that the floating couplers 48″ spans more than one anchor bolt 36 in the anchor cage 30 in the radial direction eliminates the need for a second floating coupler 48″ to create a passage 50 through the anchor cage 30 (as is the case in FIG. 2, for example).

Further, like the floating coupler 48′ of FIG. 9, the floating coupler 48″ of FIG. 11 is dimensioned so as to span more than one anchor bolt 36 in the anchor cage 30 in a tangential direction of the anchor cage 30. In the depicted embodiment, the floating coupler 48″ spans two anchor bolts 36 in the tangential direction. It should be understood that, in another embodiment, the floating coupler 48″ could be dimensioned so as to span three or more anchor bolts 36 in the tangential direction. Advantageously, dimensioning the floating coupler 48″ so that the floating coupler 48″ spans more than one anchor bolt 36 in the anchor cage 30 in the tangential direction may create a larger passage 50 (or window) through the anchor cage 30 to allow larger diameter cables (e.g., power cable(s) 52) or more cables to pass through the anchor cage 30.

While the present invention has been illustrated by a description of various embodiments and while these embodiments have been described in some detail, it is not the intention of the Applicant to restrict or in any way limit the scope of the appended claims to such detail. Additional advantages and modifications will readily appear to those skilled in the art. Accordingly, aspects of the present invention should not be limited to the specific wind turbine application disclosed herein. Moreover, the various features of the invention may be used alone or in any combination depending on the needs and preferences of the user, and the features described in the different embodiments are not dependent on one another for operation of the invention.

1. An anchor cage for a wind turbine foundation, the anchor cage comprising:
an upper load distribution flange configured to engage a lower tower flange of a wind turbine;
a lower base flange located a distance from the upper load distribution flange;
a plurality of anchor bolts extending between and coupled to the upper load distribution flange and the lower base flange; and
at least one floating coupler suspended on at least one anchor bolt of the plurality of anchor bolts, the at least one floating coupler comprising:
a first coupler plate;
a second coupler plate arranged a distance from the first coupler plate; and
a plurality of connecting members connecting the first coupler plate and the second coupler plate,
wherein a first portion of the at least one anchor bolt extends between and is coupled to the upper load distribution flange and a first coupler plate and a second portion of the at least one anchor bolt extends between and is coupled to the second coupler plate and the lower base flange, and
wherein an area bounded at least partially by the first coupler plate and the second coupler plate defines a passage through the at least one floating coupler.

2. The anchor cage of claim 1, wherein each of the plurality of connecting members is a connecting rod, and wherein each connecting rod extends between and is coupled to the first coupler plate and the second coupler plate.

3. The anchor cage of claim 2, wherein a combined tensile strength of the plurality of connecting rods is approximately equal to or greater than the tensile strength of the at least one anchor bolt.

4. The anchor cage of claim 1, wherein the first coupler plate and the second coupler plate include a foam layer on a top surface thereof, the foam layer configured to at least partially facilitate a transfer of tension between the plurality of connecting members and the at least one anchor bolt.

5. The anchor cage of claim 1, wherein at least one of the first coupler plate or the second coupler plate includes a coating on a surface thereof, the coating configured to at least partially facilitate a transfer of tension between the plurality of connecting members and the at least one anchor bolt.

6. The anchor cage of claim 1, wherein the plurality of anchor bolts includes a plurality of radially inner anchor bolts and a plurality of radially outer anchor bolts separated by a radial distance, wherein the at least one floating coupler includes a first floating coupler, suspended on a radially inner anchor bolt of the plurality of radially inner anchor bolts at a first axial height and a second floating coupler, suspended on a radially outer anchor bolt of the plurality of radially outer anchor bolts at a second axial height, and wherein the first axial height and the second axial height are substantially the same.

7. The anchor cage of claim 1, wherein the at least one floating coupler is suspended on the at least one anchor bolt such that a first distance from the upper distribution flange to the first coupler plate is less than a second distance from the lower base flange to the second coupler plate.

8. The anchor cage of claim 1, wherein the at least one floating coupler is suspended on the at least one anchor bolt such that a first distance from the upper distribution flange to the first coupler plate is substantially equal to a second distance from the lower base flange to the second coupler plate.

9. The anchor cage of claim 1, wherein a width of the passage of the at least one floating coupler is greater than a distance between a first anchor bolt and an adjacent second anchor bolt of the plurality of anchor bolts.

10. The anchor cage of claim 1, wherein the at least one anchor bolt includes a first anchor bolt and a second anchor bolt, and wherein the at least one floating coupler is suspended on at least the first anchor bolt and the second anchor bolt.

11. The anchor cage of claim 1, wherein the at least one floating coupler includes a plurality of floating couplers, and wherein the plurality of floating couplers is arranged circumferentially spaced about the anchor cage.

12. A foundation for a wind turbine, the foundation comprising:
an anchor cage comprising:
an upper load distribution flange configured to engage a lower tower flange of the wind turbine;
a lower base flange located a distance from the upper load distribution flange;
a plurality of anchor bolts extending between and coupled to the upper load distribution flange and the lower base flange;
at least one floating coupler suspended on at least one anchor bolt of the plurality of anchor bolts, the at least one floating coupler comprising:
a first coupler plate; and
a second coupler plate arranged a distance from the first coupler plate; and
a plurality of connecting members connecting the first coupler plate and the second coupler plate,
wherein the floating coupler is configured to be suspended on at least one anchor bolt, wherein a first portion of the at least one anchor bolt is coupled to the first coupler plate and a second portion of the at least one anchor bolt is coupled to the second coupler plate, and
wherein an area bounded at least partially by the first coupler plate and the second coupler plate defines a passage through the at least one floating coupler; and
a rigid body at least partially formed around the anchor cage,
wherein a conduit for a power cable passes through the passage in the foundation provided by the at least one floating coupler between an interior of the foundation and an exterior of the foundation.

13. The foundation of claim 12, wherein the first coupler plate and the second coupler plate include a foam layer on a top surface thereof, the foam layer configured to at least partially facilitate a transfer of tension between the plurality of connecting members and the at least one anchor bolt.

14. A method of forming a wind turbine foundation, the providing an anchor cage in an excavation pit formed in a ground surface, the anchor cage comprising:
an upper load distribution flange configured to engage a lower tower flange of a wind turbine;
a lower base flange located a distance from the upper load distribution flange;
a plurality of anchor bolts extending between and coupled to the upper load distribution flange and the lower base flange; and
at least one floating coupler suspended on at least one anchor bolt of the plurality of anchor bolts, the at least one floating coupler comprising:
a first coupler plate;
a second coupler plate arranged a distance from the first coupler plate; and
a plurality of connecting members connecting the first coupler plate and the second coupler plate,
wherein an area bounded at least partially by the first coupler plate and the second coupler plate defines a passage through the at least one floating coupler;
directing a cementitious material into the excavation pit so that the anchor cage becomes at least partially embedded within the cementitious material; and
allowing the cementitious material to cure to form a rigid body.
